(19) United States
(12) Patent Application Publication
(10) Pub. No.: US 2017/0307879 A1
(43) Pub. Date: Oct. 26, 2017

(54) IMAGE DISPLAY APPARATUS

(71) Applicant: CANON KABUSHIKI KAISHA, Tokyo (JP)

(72) Inventor: Takeyoshi Saiga, Tokyo (JP)

(21) Appl. No.: 15/492,060

(22) Filed: Apr. 20, 2017

(30) Foreign Application Priority Data
Apr. 25, 2016 (JP) 2016-086974

(51) Int. Cl. G02B 27/00; G06F 1/16; G02B 17/08; G09G 5/37

(52) U.S. Cl. CPC G02B 27/0081; G06F 1/1637; G09G 5/37; G02B 17/0856; G06F 1/163; G09G 2340/04

(57) ABSTRACT

An image display apparatus includes a display unit configured to display an observation image on a rectangular display area, an observation optical system configured to lead light from the display area to an exit pupil to present an observed image. The observation optical system has a distortion that leads a light flux from at least a first corner portion among four corner portions of the display area to the exit pupil so as to cause the light flux from the first corner portion to form the observed image that has a shape lacking its angled portion corresponding to the first corner portion. A display processor performs a non-display process that does not display the observation image in a second corner portion other than the first corner portion among the four corner portions of the display area.

### BACKGROUND OF THE INVENTION

### Field of the Invention

The present invention relates to an image display apparatus, such as a head mount display (“HMD”) that enables an enlarged image on a display device via an observation optical system.

### Description of the Related Art

The HMD needs a wide-angle observation optical system so as to observe an enlarged observed image using a compact display device. One small and wide-angle observation optical system may be an eccentric optical system using a rotational asymmetrical surface (free-form surface).

The distortion may occur when the observation optical system includes an eccentric (or decentering) optical system. Japanese Patent Laid-Open No. 8-149393 discloses a distortion correcting process technology for correcting (reducing) a distortion (or deformation) in an observed image (optical image) caused by the distortion of the optical system, for the observation image displayed on the display device.

However, only the distortion correcting process for the observation image cannot correct an unnatural shape of an observed image when the observation optical system has a distortion that causes the observed image to lack an angled portion corresponding to one of four corner portions of a rectangular display area in the display device. Since the observation image cannot be displayed in an area beyond the four corner portions of the display area, processing to the observation image can correct the distortion and a conventional measure simply has reduced a display size for the observation image and the observed image.

### SUMMARY OF THE INVENTION

The present invention provides an image display apparatus that makes less conspicuous an unnatural shape of an observed image caused by a distortion. The present invention provides as an aspect thereof an image display apparatus according to one aspect of the present invention includes a display unit configured to display an observation image in its rectangular display area, an observation optical system configured to lead light from the display area to an exit pupil to present an observed image, the observation optical system having a distortion that leads a light flux from at least a first corner portion among four corner portions of the display area to the exit pupil so as to cause the light flux from the first corner portion to form the observed image that has a shape lacking its angled portion corresponding to the first corner portion, and a display processor configured to perform a non-display process that does not display the observation image in a second corner portion other than the first corner portion among the four corner portions of the display area.

The present invention provides as another aspect thereof an image display apparatus including a display unit configured to display an observation image on its rectangular display area, an observation optical system configured to lead light from the display area to an exit pupil to present an observed image, the observation optical system having a distortion that leads a light flux from at least a first corner portion among four corner portions of the display area to the exit pupil so as to cause the light flux from the first corner portion to form the observed image that has a shape lacking its angled portion corresponding to the first corner portion, and a light shield configured to prevent a light flux from the second corner portion from reaching the exit pupil.

Further features of the present invention will become apparent from the following description of exemplary embodiments with reference to the attached drawings.

### BRIEF DESCRIPTION OF THE DRAWINGS

FIG. 1 illustrates a configuration of an image display apparatus according to a first embodiment of the present invention.

FIG. 2A illustrates a rectangular display area on a display device according to the first embodiment.

FIG. 2B illustrates a distortion in an observation optical system.

FIG. 3 illustrates an observed image when a distortion correcting process is performed for an observation image according to the first embodiment.

FIG. 4 illustrates an observed image that has received a non-display process according to the first embodiment.

FIG. 5 illustrates a configuration of an image display apparatus according to a second embodiment of the present invention.

FIG. 6 illustrates a configuration of an image display apparatus according to a third embodiment of the present invention.

### DESCRIPTION OF THE EMBODIMENTS

A description will now be given of embodiments of the present invention with reference to the accompanying drawings.

### First Embodiment

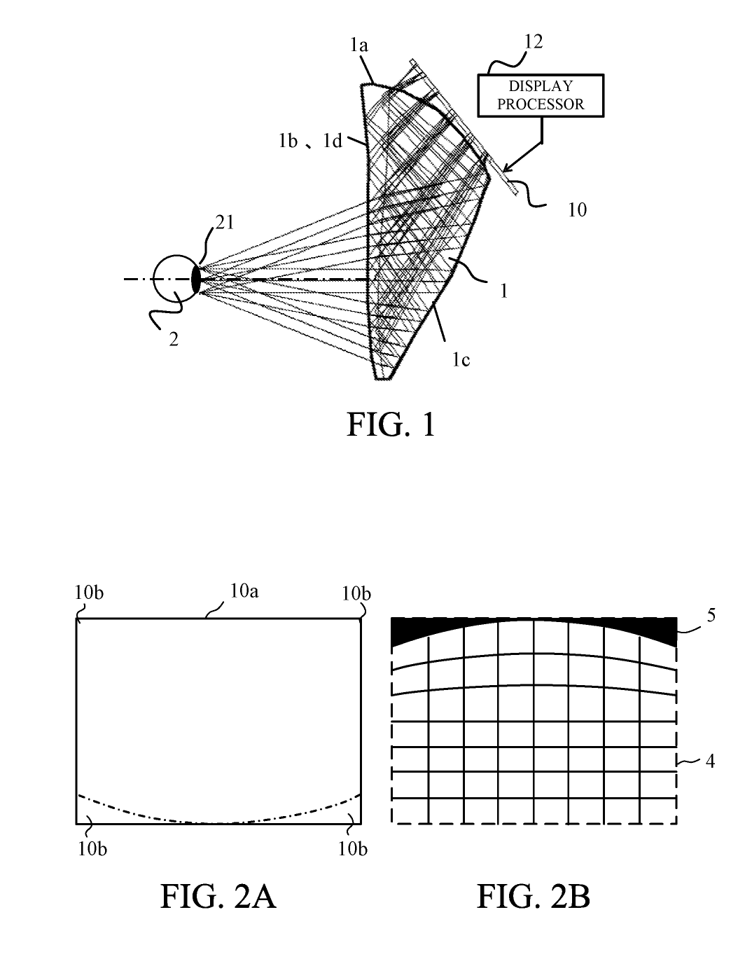

FIG. 1 illustrates a configuration of an HMD as an image display apparatus according to a first embodiment of the present invention. A display device 10, such as an LCD and an organic EL, displays an observation image as an image (original image) to be observed by an observer. Light from the display device (observation image) is led to an exit pupil 21 via an observation optical system 1. A pupil 2 of an observer is disposed at the position of the exit pupil 21. A display processor 12 provides a display process (display control) that controls displaying the observation image on the display device 10 based on a video signal input from the outside.

The observation optical system 1 includes a first surface 1a as a refractive surface that transmits the light from the display device 10 (observation image), a second surface 1b as a transmissive and reflective surface that totally reflects the light from the first surface 1a, a third surface 1c as an evaporated reflective surface that reflects the light from the second surface 1b. The observation optical system 1 further includes a fourth surface 1d that serves as or is common to the second surface 1b and transmits the light from the third surface 1c to the exit pupil. The observation optical system 1 includes a prism-shaped optical element covered with the first surface 1a to the fourth surface 1d, and the inside of the prism-shaped optical element is filled with a medium having a refractive index higher than 1. The observation optical system 1 is an eccentric (or decentering) optical system, and two or more (desirably, at least three) of the first surface 1a to the fourth surface 1d are rotationally asymmetric surfaces (free-form surfaces). This configuration corrects the eccentric aberration, and presents an observed image as an enlarged optical image (enlarged virtual image) of the observation image, to the observer. However, the eccentric optical system causes an asymmetrical distortion in the eccentric direction.

Referring now to FIGS. 2A and 2B, a description will be given of an asymmetrical distortion in the observation optical system 1 according to this embodiment. FIG. 2A illustrates a rectangular display area 10a of the display device 10. Without a non-display process, which will be described later, the display area 10a can displays the observation image over four corner portions 10b. The observation optical system 1 has a distortion that distorts an observed image (illustrated by a broken line) 4, as illustrated in FIG. 2B. More specifically, the observation optical system 1 generates a distortion causing light fluxes from the upper left and right corner portions (first corner portions) 10b among the four corner portions 10b of the display area 10a to form an observed image (illustrated by the meshed line) 4 that has a shape including no upper left and right angled portions (first angled image portions) 5 corresponding to the left and right corner portions 10b. Having no angled portions 5 means that the angled portions 5 that would originally have a right angle are rounded or chamfered due to the distortion.

As described above, a negative distortion occurs when a light ray is traced sequentially from the display device 10 (observation image) to the exit pupil 21, and this distortion is an asymmetrical distortion in the longitudinal direction (in a short-side direction of the display area 10a). The negative distortion of the observation optical system 1 generates a larger distortion for the upper left and right angled portions of the observation image than that for lower left and right angled portions (second angled image portions) thereof corresponding to lower left and right corner portions (second corner portions) 10b of the display area 10a. Thus, the observer may recognize an unnatural shape of the observed image.

The display processor 12 in this embodiment as a computer including a processor (a CPU and an MPU) performs the following distortion correcting process and non-display process in accordance with a display process program.

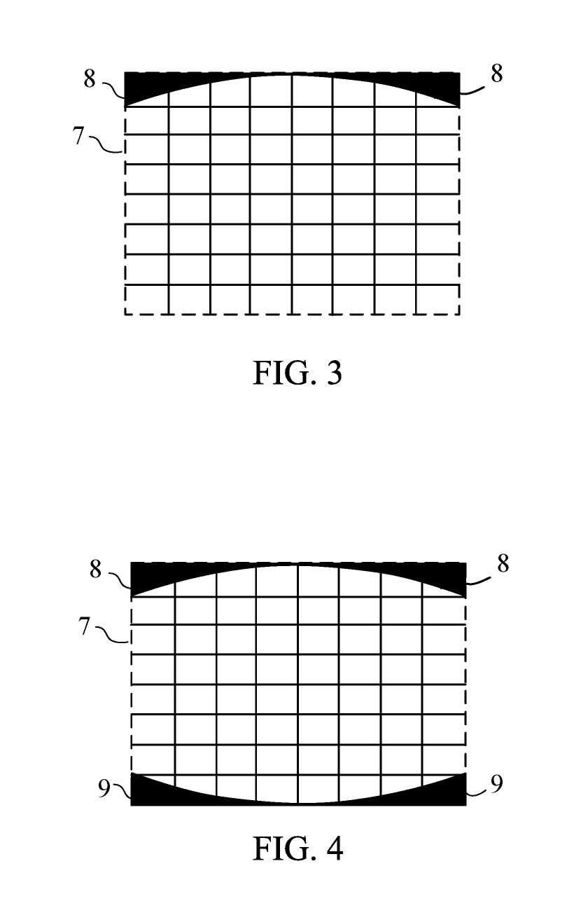

FIG. 3 illustrates an observed image 7 observed after the distortion correcting process is performed for the observation image. In FIG. 3, the distortion is corrected (reduced) in the internal part in the observation image 4 illustrated in FIG. 2B, although the observed image still has no upper left and right angled portions 8. In other words, only the distortion correcting process for the observation image cannot correct an unnatural shape of the observed image.

FIG. 4 illustrates an observed image 7 when the non-display process is performed for the lower left and right corner portions 10b (second corner portions illustrated by an alternate short and long dashed line) different from (other than) the upper left and right corner portions 10b (other than the first corner portions) among the four corner portions 10b of the display area 10a illustrated in FIG. 2A. The non-display process is a process that prevents the observation image corresponding to the image signal from the outside from being displayed, such as, using a dark display process that expresses the observation image in black or in a dark color close to black. In other words, the non-display process is a process that puts the observed image corresponding to the image signal from the outside, out of sight of the observer. In further other words, the non-display process is a process that does not display the lower left and right angled portions of the observation image on the display area 10a.

Due to this non-display process, the observed image 7 has no lower left and right corner portions 9 as well as no upper left and right corner portions 5. Thus, the observed image 7 has a symmetrical or an approximately symmetrical shape in the longitudinal direction when the non-display process is performed in comparison with a case where the non-display process is not performed, and the observer is less likely to recognize an unnatural shape of the observed image. In addition, the observed image 7 illustrated in FIG. 4 is derived from the observation image that has received the distortion correcting process, and thus the observer is less likely to recognize the unnatural shape.

This embodiment can correct the observed image through the above non-display process, when the observed image asymmetrically lacks angled portions that would not be corrected by the distortion correcting process to the observation image. In other words, this embodiment forms the observed image that symmetrically lacks angled portions in the longitudinal direction and in the lateral direction, and prevents the observer from easily recognizing the unnatural shape of the observed image.

The shape of the observed image that has received the non-display process is not necessarily symmetrical or almost symmetrical in the longitudinal direction or in the lateral direction, as long as the observer is less likely to recognize an unnatural shape of the observed image when the non-display process is performed than when the non-display process is not performed.

The shape and the number of surfaces of the observation optical system 1 illustrated in FIG. 1 are merely illustrative, and an observation optical system having another shape and another number of surfaces may be used. The present invention may use an observation optical system configured to once internally image light from the observation image, an observation optical system that includes only a reflective surface or a transmissive surface, an observation optical system that includes two or more optical elements, etc.

### Second Embodiment

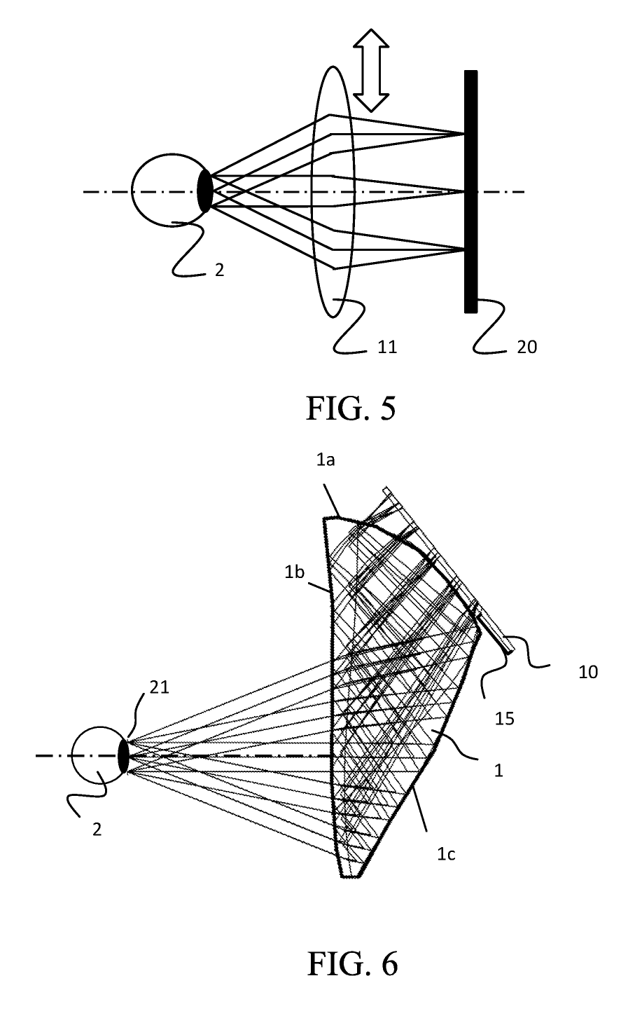

FIG. 5 illustrates an observation optical system according to a second embodiment of the present invention. In FIG. 5, reference numeral 11 denotes a rotationally symmetrical observation optical system, and reference numeral 20 denotes a display device.

In this embodiment, even when the observation optical system 11 is designed to be rotationally symmetrical, the observation optical system 11 possesses the asymmetrical distortion that contains a keystone distortion due to actual manufacturing and assembly errors. Then, the observer observes an observed image that asymmetrically lacks angled portions. Unlike the first embodiment, the asymmetrical direction may be a diagonal direction in addition to the longitudinal direction and the lateral direction. Moreover, the observer may observe an observed image that lacks only one of the four angled portions.

Even in this case, similar to the first embodiment, the non-display process may be performed for at least one corner portion (second corner portion) on the rectangular display area in the display device 20. For example, assume that the observer observes an observed image that lacks two angled portions in one longitudinal direction on the right or left side or in one diagonal direction. Then, the non-display process sets to the non-display state the corner portions 10b corresponding to two angled portions in the other longitudinal direction on the right or left side or in the other diagonal direction. When the observer observes an observed image that lacks only one corner portion, the non-display process may set the corner portions 10b corresponding to the three other angled portions to the non-display state.

This embodiment can also correct the observed image that asymmetrically lacks angled portions that would not be corrected only by the distortion correcting process to the observation image, whereby the observed image symmetrically lacks angled portions in the longitudinal and lateral directions, and the observer is less likely to recognize an unnatural shape of the observed image.

The non-display process can be performed irrespective of the configuration of the observation optical system 11, or whether the observation optical system has a rotationally asymmetrical surface, or whether the observation optical system is an eccentric optical system, etc.

### Third Embodiment

The first and second embodiments correct the asymmetric shape of the observed image using the non-display process for the observation image on the display device. Alternatively, the first and second embodiments may not set the corner portions (second corner portions) 10b of the display area 10a to the non-display state and may prevent the light fluxes from these corner portions 10b from reaching the exit pupil.

More specifically, as illustrated in FIG. 6, for example, a light shield member 15, such as a film and paint, is provided so as to cover the two corner portions 10b or those which have received the non-display process in the first embodiment, on the display area 10a in the display device 10. The light shield member 15 may be provided on the optical element in the observation optical system 1 rather than on the display device 10.

The light shield member 15 is made movable between a position that covers the two corner portions 10b and a position that does not cover the two corner portions 10b, and a user can arbitrary set one the these positions. Thereby, the user can observe the observed image derived from the observation image with the corner portions 10b uncovered by the light shield member 15.

As described above, each embodiment does not partially display the observation image or shields the light from the observation image, and makes less conspicuous an unnatural shape of an observed image caused by the distortion.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-086974, filed Apr. 25, 2016, which is hereby incorporated by reference herein in its entirety.

What is claimed is:

1. An image display apparatus comprising:
a display unit configured to display an observation image on its rectangular display area;
an observation optical system configured to lead light from the display area to an exit pupil to present an observed image, the observation optical system having a distortion that leads a light flux from at least a first corner portion among four corner portions of the display area to the exit pupil so as to cause the light flux from the first corner portion to form the observed image that has a shape lacking its angled portion corresponding to the first corner portion; and
a display processor configured to perform a non-display process that does not display the observation image in a second corner portion other than the first corner portion among the four corner portions of the display area.

2. The image display apparatus according to claim 1, wherein the non-display process sets the second corner portion to a dark display state.

3. The image display apparatus according to claim 1, wherein the display processor performs a correction process on the observation image so as to reduce a distortion in the observed image caused by the distortion of the observation optical system.

4. The image display apparatus according to claim 1, wherein the distortion of the observation optical system is a negative distortion.

5. The image display apparatus according to claim 4, wherein:
the negative distortion of the observation optical system generates a larger distortion for a first angled image portion of the observation image corresponding to the first corner portion than that for a second angled image portion corresponding to the second corner portion; and
the display processor performs the non-display process that does not display the second angled image portion on the display area.

6. The image display apparatus according to claim 1, wherein the observation optical system is an eccentric optical system having at least one rotationally asymmetric surface.

7. The image display apparatus according to claim 6, wherein the observation optical system includes:
a first surface that transmits the light from the display area;
a second surface that reflects the light from the first surface;
a third surface that reflects the light from the second surface; and
a fourth surface that transmits the light from the third surface to the exit pupil,
wherein the second surface and the fourth surface are common transmissive and reflective surfaces, and
wherein at least three of the first surface to the fourth surface are rotationally asymmetrical surfaces.

8. An image display apparatus comprising:
a display unit configured to display an observation image on its rectangular display area;
an observation optical system configured to lead light from the display area to an exit pupil to present an observed image, the observation optical system having a distortion that leads a light flux from at least a first corner portion among four corner portions of the display area to the exit pupil so as to cause the light flux from the first corner portion to form the observed image that has a shape lacking its angled portion corresponding to the first corner portion; and
a light shield configured to prevent a light flux from the second corner portion from reaching the exit pupil.

9. The image display apparatus according to claim 8, wherein the display device includes the light shield.

10. The image display apparatus according to claim 8, wherein the distortion of the observation optical system is a negative distortion.

11. The image display apparatus according to claim 10, wherein the observation optical system is an eccentric optical system having at least one rotationally asymmetric surface.

12. The image display apparatus according to claim 11, wherein the observation optical system includes:
a first surface that transmits the light from the display area;
a second surface that reflects the light from the first surface;
a third surface that reflects the light from the second surface; and
a fourth surface that transmits the light from the third surface to the exit pupil,
wherein the second surface and the fourth surface are common transmissive and reflective surfaces, and
wherein at least three of the first surface to the fourth surface are rotationally asymmetrical surfaces.

13. An image display apparatus comprising:
a display unit configured to display an observation image on its rectangular display area including first, second, third and fourth corner portions;
an observation optical system configured to lead light from the display area to an exit pupil to present an observed image,
wherein:
the distortion of the observation optical system is a negative distortion and generates a larger distortion for a first angled image portion of the observation image corresponding to the first corner portion than that for a second angled image portion corresponding to the second corner portion; and
the display processor performs the non-display process that does not display the second angled image portion on the display area.
